(19) United States
(12) Patent Application Publication
(10) Pub. No.: US 2006/0037418 A1
(43) Pub. Date: Feb. 23, 2006

(54) Apparatus for converting rotary motion to a rectilinear force

(76) Inventor: Frederick L. Dehen, Portland, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 10/922,061

(22) Filed: Aug. 18, 2004

(51) Int. Cl. F16H 27/04

(52) U.S. Cl. 74/84 S

(57) ABSTRACT

An apparatus for converting rotary motion to rectilinear force has an eccentrically unbalanced flywheel whose rotational speed varies through each rotation so that the unbalance is oriented in a particular direction. The flywheel has a weight protruding from one side surface which is made from a ferromagnetic material. A first magnet is located radially outwardly adjacent the weight when the weight rotates past it, and a second magnet, which is substantially diametrically opposed to the first magnet, is located radially inwardly adjacent to the weight when the weight rotates past it. The first and second magnets are moveable between a first position where there is a high level of magnetic attraction between them and the weight, and a second position where there is substantially no attraction.

### BACKGROUND AND SUMMARY OF THE INVENTION

Dehen, U.S. Pat. No. 4,347,752 and McMahon, U.S. Pat. No. 5,167,163 disclose apparatus which convert rotary motion to a rectilinear force by rotating an eccentrically unbalanced flywheel in a manner such that the amount of unbalance varies as the flywheel makes a rotation. The device disclosed in the former patent accomplishes this by varying the rotational speed of the flywheel during its rotational cycle. The device disclosed in the former patent places four of these apparatus on a platform to provide movement of the platform rotationally or in any direction. This directional control is accomplished by selectively varying the motor speed and the direction of the force created by the eccentrically unbalanced flywheel. While this system does provide directional control it is desirable to be able to vary the direction in which the platform moves in a manner which is more responsive.

The subject invention accomplishes this by having the weight which creates the unbalance protrude from the side surface of the flywheel and having it be ferromagnetic. A first magnet is located radially outwardly adjacent to this weight when the weight rotates past the first magnet, and a second magnet is located radially outwardly adjacent to the weight when the weight rotates past the second magnet.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a first end elevational view of an apparatus embodying the subject invention.

FIG. 1B is the opposite end elevational view of the apparatus in FIG. 1.

FIG. 2A is a first side elevational view of the apparatus of FIG. 1.

FIG. 2B is the opposite side elevational view of the apparatus of FIG. 1.

FIG. 3 is a sectional view taken along the line 3-3 of FIG. 2A.

FIG. 4 is a schematic plan view showing four of the apparatus mounted on a single platform.

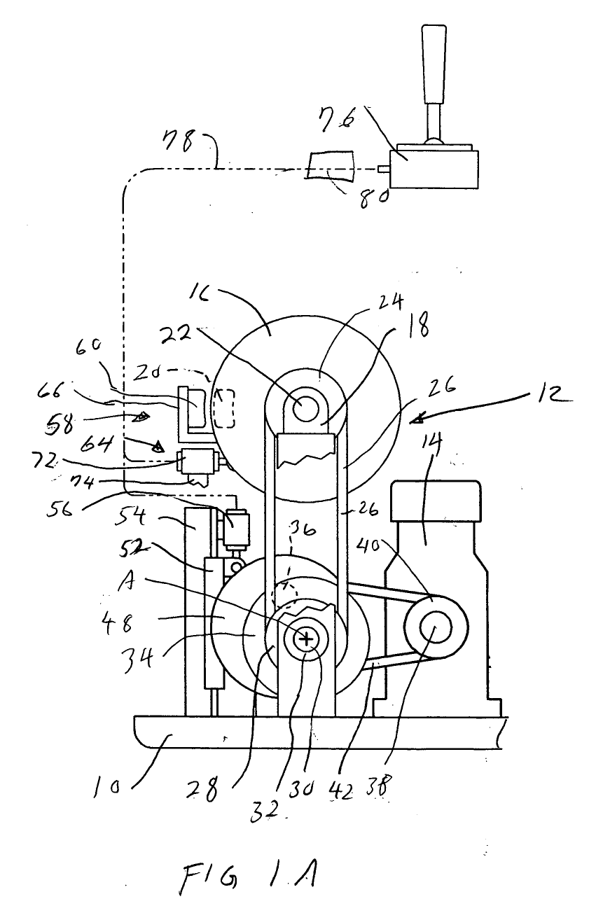

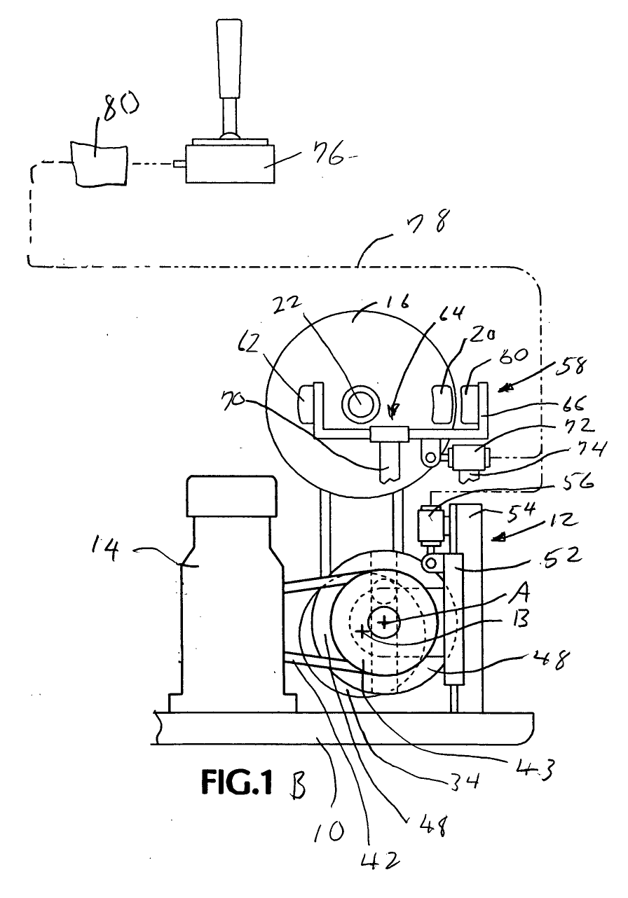

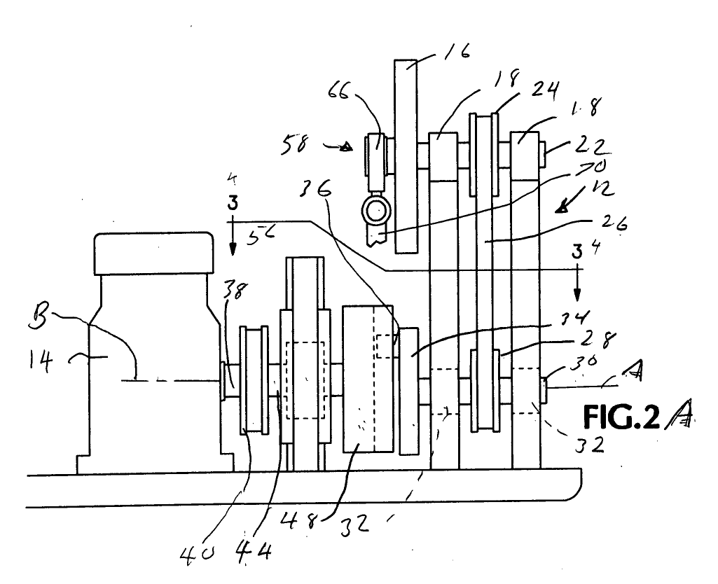

The foregoing and other objectives, features, and advantages of the invention will be more readily understood upon consideration of the following detailed description of the invention, taken in conjunction with the accompanying drawings.

### DETAILED DESCRIPTION OF THE PREFERRED EMBODIMENT

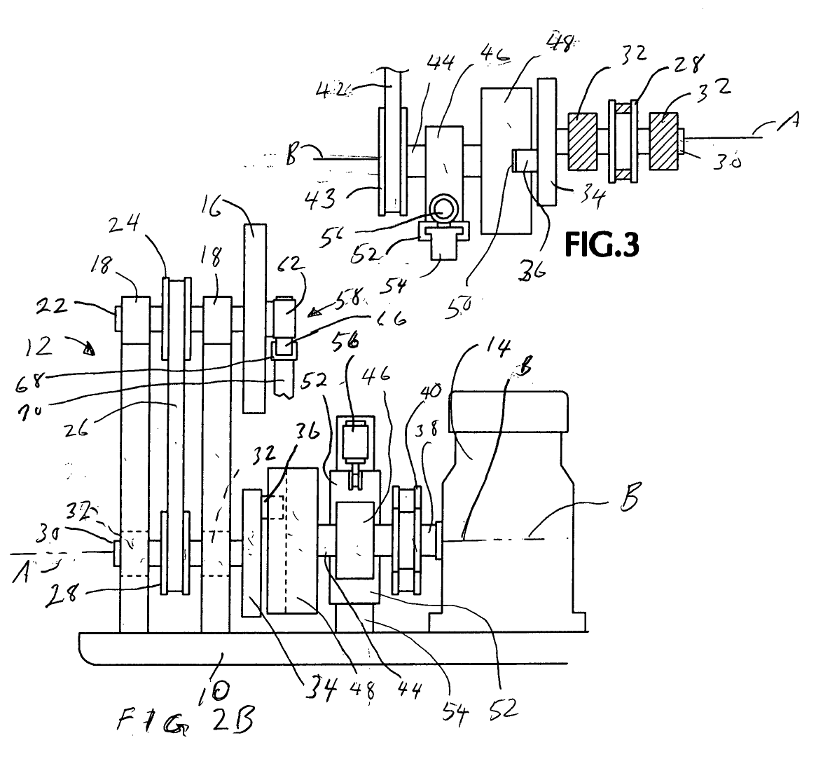

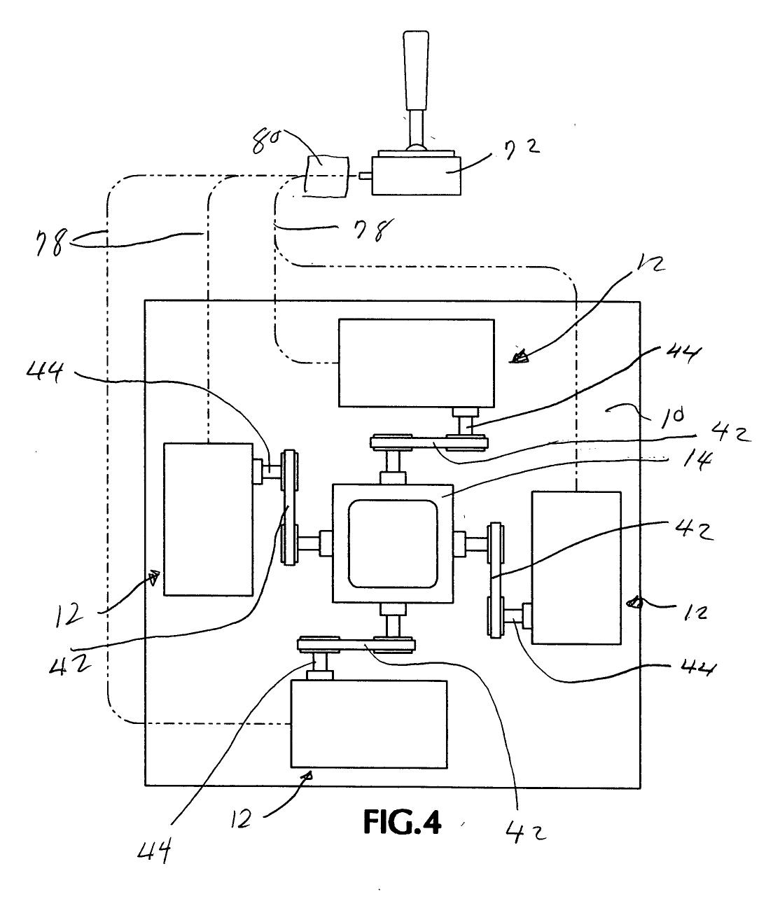

Referring to the drawings, a platform 10 carries four apparatus 12 which convert rotary motion to a rectilineal force. All four apparatus are powered by a single motor through an appropriate gear box (shown schematically together as 14). Each apparatus contains a large flywheel 16 which is mounted on a shaft 22 which is rotatably journaled in bearings 18 that are mounted on the platform 10. Located on one face of the flywheel, proximate its outer periphery, is a weight 20. The weight can be mounted on a track system (not shown) which allow it to be moved radially inward and outward on the flywheel. In the embodiment illustrated the shaft 22 also carries a pulley 24. The pulley 24 is driven by a belt 26 which extends around a second pulley 28 which is mounted on a shaft 30. Shaft 30 is rotatably journaled in a bearings 32. Also attached to the shaft 30 is a cam follower 34. Projecting from one face of the cam follower is a pin 36, FIG. 3, which is parallel with but offset from the axis A of the shaft 30.

Attached to each output shaft 38 of the motor gear box 14 is a pulley 40. A belt extends between the pulley 40 and a pulley 43 which is mounted on a shaft 44 which is journaled in a bearing 46. The shaft 44 rotates about an axis B which is parallel to and offset from axis A. Located on the other end of the shaft 44 is a cam 48. The cam 48 has a diametric slot 50 which is configured to slidably engage the pin 36 of the cam follower 34. The cam and cam follower are arranged so that pin 36 remains in the slot 50 when the cam members are rotated by the motor 34 even though their respective axes are offset. This will occur when the length of the slot 50 is twice as great as the distance between axes A and B plus the distance the pin 36 is offset from axis A. When the motor 14 is operated shaft 44, and thus cam 48, is rotated at a constant speed. As the cam 48 is rotated the interaction of pin 36 in slot 50 causes cam follower 34 to rotate also. However, since axis A, about which cam follower 34 rotates on shaft 30, is offset from axis B, about which cam element 48 rotates on shaft 44, the cam follower 34 and shaft 30 do not rotate at a constant rate of speed. As the cam follower 34 is rotated, pin 36 moves radially inwardly and outwardly in slot 50 due to the offset of axes A and B. Accordingly, its circumferential speed is increased and decreased as it travels between portions of the cam having respectively higher or lower circumferential speeds. Therefore, the rotational speed of cam follower 34 varies cyclically during its rotation.

Since an eccentrically unbalanced wheel imparts an unbalanced force to its supporting structure which is proportionate to the amount of unbalance and the speed at which it is rotated, the unbalanced force becomes biased due to the variation of rotational speed of the flywheel 16. Thus, the device is urged towards the direction of unbalance, which lies in that portion of the rotational cycle having the increased speed. In addition, by changing the relative angular displacement of axes A with respect to axes B, the direction at which the unbalance is oriented can be changed. To accomplish this the bearing 46, which journals the shaft 44 that the cam follower 48 is mounted on, is attached to a slotted track 52. The track 52 fits slidably over a rail 54 which extends upwardly from the platform 10. A piston cylinder 56 is placed between the track 52 and rail 54. Thus, activation of the piston cylinder 56 causes the bearing 46 to be raised and lowered relative to the platform 10. As this occurs the axis A is also raised or lowered relative to the platform and, since the axis B does not move, the amount of offset between axes A and B changes. As mentioned above, this changes the direction of the force and balance created by the cyclic rotation of the eccentrically unbalanced flywheel. While selectively controlling the amount of offset between axes A and B on the four apparatus will allow control over the direction of movement of the platform, changes in direction may not be as quick or as smooth as desired.

To rectify this an augmentation system 58 is provided which provides for rapid augmentation of the force created by the flywheel. The augmentation system includes having the weight 20 be made from a ferromagnetic material. A first magnet 60 is located radially outwardly of where the weight 20 passes as the flywheel 16 rotates. A second magnet 62 is located radially inwardly of where the weight 20 passes as the flywheel rotates. The first and second magnets are generally diametrically opposed across the flywheel from one another, however, they may be separated by less than 180° depending on the particular use of the device. It also is preferable that the first magnet is located approximately where the weight 20 reaches its maximum speed. However, since the place where this occurs depends on the offset between the axes A and B, and because this offset can be changed the first magnet will not always be at the exact point where the weight 20 reaches its maximum speed. Moreover, the four apparatus can be arranged such that the point of maximum speed, and the orientation of the first and second magnets, is different for each apparatus.

The first and second magnets are mounted on an activation mechanism 64 which allows the first and second magnets to be moved between a first position and a second position. In the first position the gap between the magnets and the weight is quite small and the magnets create the maximum force on the weight. In the second position the gap is large enough that essentially no force is created on the weight. The activation system includes an arm 66 which has the first and second magnets 60, 62 at its opposite ends. The arm is slidably carried in a sleeve 68 which is attached to the platform through a stand 70. A piston cylinder 72, which is mounted on the platform through a mount 74, is connected to the arm 66 to move it between its first and second positions.

The piston cylinders 54 and 72 are connected to a controller 76 through lines 78 and a computer 80. The computer is configured to selectively activate the piston cylinders in a manner which allows a user to cause the platform to move in any desired direction by manipulation of the controller.

Instead of the weight being made from a ferromagnetic material and magnets being mounted on the arm 66, the weight could be a magnet and ferromagnetic blocks could be mounted on the arms.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. In an apparatus which converts rotary motion to a rectilinear force by rotating a flywheel having a weight attached to a side surface thereof such that the rotational speed of the flywheel cyclically varies through each rotation, the improvement comprising:
(a) the weight protruding from the side surface of the flywheel and being ferromagnetic;
(b) a first magnet which is located radially outwardly adjacent the weight when the weight rotates past said first magnet; and
(c) a second magnet which is located radially inwardly adjacent the weight when the weight rotates past said second magnet.

2. The apparatus of claim I wherein said first and second magnets are substantially diametrically opposed across the flywheel.

3. The apparatus of claim 1 wherein said first magnet is located proximate where said weight reaches its maximum speed.

4. The apparatus of claims 1, 2 or 3, further including:
(a) A bracket which carries said first and second weights; and
(b) an activation mechanism which allows movement of said bracket between a first position where said first magnet creates a radially outwardly directed force on the weight when the weight rotates past said first magnet and said second magnet creates a radially inward directed force on the weight when the weight rotates past said second magnet, and a second position where said magnets do not create a substantial force on the weight when the weight rotates past said magnets.

5. In an apparatus which converts rotary motion to a rectilinear force by rotating a flywheel having a weight attached to a side surface thereof such that the rotational speed of the flywheel cyclically varies through each rotation, the improvement comprising:
(a) The weight protruding from the side surface of the flywheel and being magnetic;
(b) a first block of ferromagnetic material which is located radially outwardly adjacent the weight when the weight rotates past first block; and
(c) a second ferromagnetic block which is radially inwardly adjacent the weight when the weight rotates past said second block.

6. The apparatus of claim 5 wherein said first and second blocks are substantially diametrically opposed across the flywheel.

7. The apparatus of claim 5 wherein said first block is located proximate where the weight reaches its maximum speed.

8. The apparatus of claims 5, 6 or 7 further including:
(a) A bracket which carries said first and second blocks; and
(b) an actuation mechanism for moving said bracket between a first position where said weight creates a radially outwardly directed force on said first block when the weight rotates past said first block and the weight creates a radially inwardly directed force on said second block when the weight rotates past said second block, and a second position where the weight does not create a substantial force on said blocks when the weight rotates past said blocks.

9. A device, comprising a platform having at least four of the apparatus of claim 4 mounted thereon, said apparatus being oriented such that the flywheels of at least two of said apparatus rotate about a first axis of said platform and the flywheels of at least two of said apparatus rotate about a second axis of said platform, and said first and second axes being perpendicular to one another.

10. The device of claim 9 further including a control system which allows individual selective movement of the activation mechanisms of said at least four of the apparatus of claim 4 between the first and second positions.

11. The device of claim 10 wherein said control system allows coordinated selective movement of the actuation mechanisms of said at least four of the apparatus of claim 4.
